(19) United States
(12) Patent Application Publication
(10) Pub. No.: US 2015/0135887 A1
(43) Pub. Date: May 21, 2015

(54) DRIVER-PROTECTING BRAKE PEDAL APPARATUS

(71) Applicants: Hyundai Motor Company, Seoul (KR); Dong Hee Industrial Co., Ltd., Ulsan (KR)

(72) Inventors: Eun Sik KIM, Gwangmyeong-si (KR); Ean Soo CHO, Hwaseong-si (KR); Wi Sang PARK, Ulsan (KR)

(73) Assignees: Hyundai Motor Company, Seoul (KR); Dong Hee Industrial Co., Ltd., Ulsan (KR)

(21) Appl. No.: 14/470,693

(22) Filed: Aug. 27, 2014

(30) Foreign Application Priority Data
Nov. 19, 2013 (KR) 10-2013-0140954

(51) Int. Cl. B60T 7/06

(52) U.S. Cl. CPC B60T 7/065
USPC 74/512

(57) ABSTRACT

A driver-protecting brake pedal apparatus may include a pedal member fixed to a dash panel, a hinge bracket, a first end of which may be pivotally coupled to the pedal member, the hinge bracket being selectively separated from the pedal member by an external force in order to maintain a pedal ratio, and a pedal arm rotatably coupled with a second end of the hinge bracket via a pedal hinge.

### CROSS REFERENCE TO RELATED APPLICATION

The present application claims priority to Korean Patent Application No. 10-2013-0140954, filed on Nov. 19, 2013, the entire contents of which is incorporated herein for all purposes by this reference.

### BACKGROUND OF THE INVENTION

1. Field of the Invention

The present invention relates, in general, to a driver-protecting brake pedal apparatus and, more particularly, to a driver-protecting brake pedal apparatus which has a reverse lever which separates a pedal arm from a pedal member in an accident, and which can be universally used in all types of vehicles.

2. Description of Related Art

FIG. 1 shows the structure of a typical brake pedal apparatus. The brake pedal apparatus includes a pedal member 2 which is fixed to a dash panel 1 and protrudes into a cabin and a pedal arm 4 which is rotatably coupled with the pedal member 2 via a pedal hinge 3. The pedal arm 4 is connected to a brake booster 6 via a push rod 5.

In addition, in order to prevent the lower limbs (the ankles, thighs, or the like) of a driver from being injured by the pedal arm 4 in an accident, such as a collision or a rear-end collision, an approach in which the pedal member 2 is provided with a reverse lever 8 via a lever hinge 7 was proposed.

In an accident, such as a collision or a rear-end collision, when the pedal member 2 is pushed into the cabin side (the direction indicated by an arrow M1) and the reverse lever 8 is brought into contact with a cowl crossbar 9, a lever protrusion 8a of the reverse lever 8 contacts and pushes the pedal hinge 3 while the reverse lever 8 rotates counterclockwise about the lever hinge 7 from the shown position. Due to this, the pedal arm 4 is separated from the pedal member 2, and at this time, the lower end of the pedal arm 4 is forcibly rotated forward (in the direction indicated by an arrow R1) to maximize the distance between the pedal arm 3 and the legs of the driver, thereby minimizing the injury of the driver caused by the pedal.

However, the related-art brake pedal apparatus as described above has a drawback in that it cannot be universally used in all vehicles.

That is, the length of the push rod 5 and the pedal ratio A:B=3:1 are factors that are fixed for guaranteeing the performance of the brake in all types of vehicles. However, the position where a brake booster 6 is disposed or the position of a pad point P1 is a variable that varies depending on the type of vehicle.

In the pedal ratio A,B, A is the distance between the pad point P1 and the center of pedal hinge 3, B is the distance between the point where the pedal arm 4 is coupled with the push rod 5 to the center of the pedal hinge 3.

The position where the brake booster 6 is positioned is a variable that varies depending on a change in layout depending on the type of vehicle, and the position of the pad point P1 is a variable that varies depending on a change in the position where a seat is disposed depending on the type of vehicle.

When the position where the brake booster 6 is disposed or the position of the pad point P1 is changed depending on the type of vehicle as described above, the position where the pedal hinge 3 is disposed must be changed in a corresponding fashion in order to maintain the pedal ratio A,B. According to the structure of the related art, the pedal hinge 3 is fixed to a specific position of the pedal member 2, and thus it is impossible to reposition the pedal hinge 3. Therefore, a new brake pedal apparatus must be developed to be used depending on the type of vehicle. The brake pedal apparatus cannot be universally used in all types of vehicles, which is problematic.

The information disclosed in the Background of the Invention section is only for the enhancement of understanding of the background of the invention, and should not be taken as an acknowledgment or any form of suggestion that this information forms a prior art that would already be known to a person skilled in the art.

### BRIEF SUMMARY

Various aspects of the present invention are directed to providing a driver-protecting brake pedal apparatus which includes a reverse lever, and which can be universally used in all types of vehicles.

In an aspect of the present invention, a driver-protecting brake pedal apparatus may include a pedal member fixed to a dash panel, a hinge bracket, a first end of which is pivotally coupled to the pedal member, the hinge bracket being selectively separated from the pedal member by an external force in order to maintain a pedal ratio, and a pedal arm rotatably coupled with a second end of the hinge bracket via a pedal hinge.

The driver-protecting brake pedal apparatus may further include a reverse lever, wherein the reverse lever is rotatably disposed via a lever hinge which pivotally couples both a first end of the pedal member and the first end of the hinge bracket.

The reverse lever may include a lever protrusion engaged with the pedal hinge such that when the lever protrusion pushes the pedal hinge by the external force, the hinge bracket rotates with respect to the lever hinge.

The pedal member may include member side sections disposed at both sides to be parallel to each other, plate coupling sections bent outward from front ends of the member side sections for coupling with a base plate, and a member-connecting section connecting front upper surfaces of the member side sections which adjoin to the plate coupling sections to each other in a transverse direction in order to maintain lateral stiffness.

The hinge bracket is disposed to be positioned inside an inner space of the pedal member which spans from a rear end to the member-connecting section of the pedal member.

The inner space of the pedal member is opened such that a position where the hinge bracket is disposed is changeable in order to maintain the pedal ratio.

Each of the member side sections may have a pedal operation recess which is opened downward and is recessed upward, wherein a rear surface of the pedal operation recess is configured as an inclined surface in order to avoid interruption with either the pedal arm or the pedal hinge when the pedal hinge is separated from the pedal member and the pedal arm rotates forward in response to an operation of the reverse lever.

The inclined surface of the pedal operation recess may have an angle of incline with which a size of the pedal operation recess is increased gradually in a downward direction.

The hinge bracket may include bracket side sections disposed at both sides to be parallel to the member side sections, wherein the bracket side sections may have first hinge holes through which the pedal hinge extend and second hinge holes through which the lever hinge extends, and a bracket-connecting section connecting rear ends of the bracket side sections to each other in a transverse direction in order to maintain lateral stiffness.

The reverse lever is disposed so as to satisfy all of three conditions including a distance between a center of the pedal hinge and a center of the lever hinge, a distance between the center of the lever hinge and a center of a cowl crossbar that is positioned above the lever hinge, and a distance between one end of the cowl crossbar and the reverse lever.

According to various aspects of the present invention as set forth above, since the pedal member and the hinge bracket are configured separately from each other, the brake pedal apparatus can be universally used in all types of vehicles, thereby reducing a manufacturing cost and improve the value of a product.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view illustrating a driver-protecting brake pedal apparatus of the related art.

FIG. 2 and FIG. 3 are perspective and side elevation views showing a driver-protecting brake pedal apparatus according to an exemplary embodiment of the present invention.

FIG. 4 is an exploded perspective view illustrating the pedal member and the hinge bracket according to an exemplary embodiment of the present invention.

FIG. 5 is a perspective view of the pedal member according to an exemplary embodiment of the present invention.

FIG. 6 is a view illustrating a condition where the reverse lever is disposed according to an exemplary embodiment of the present invention.

FIG. 7 is a view illustrating the reverse rotation of the pedal arm in an accident.

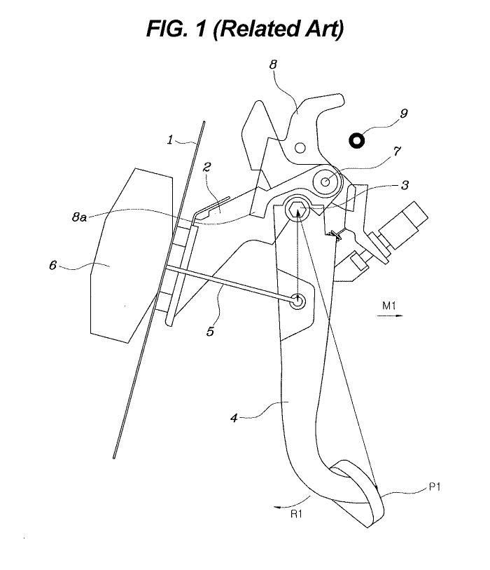

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

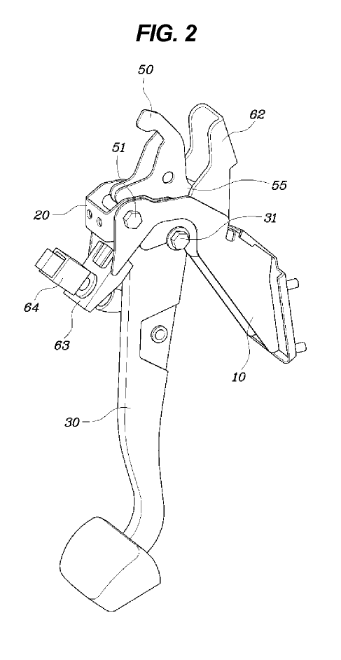

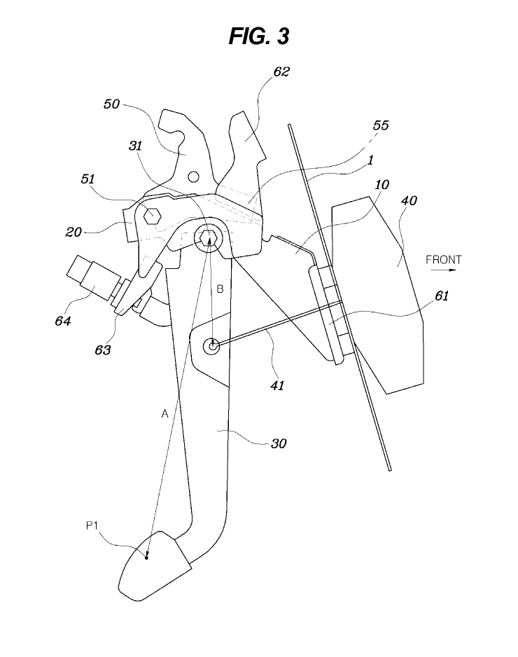

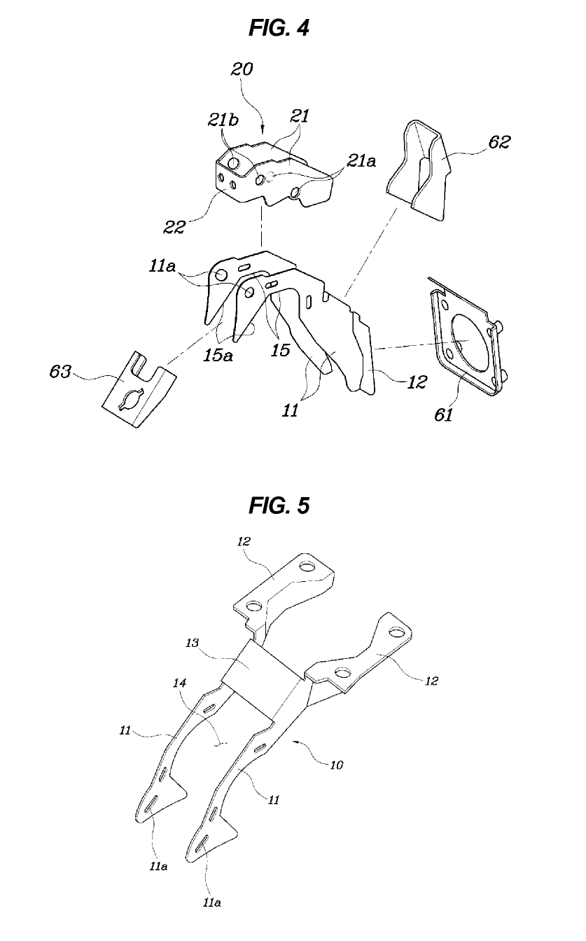

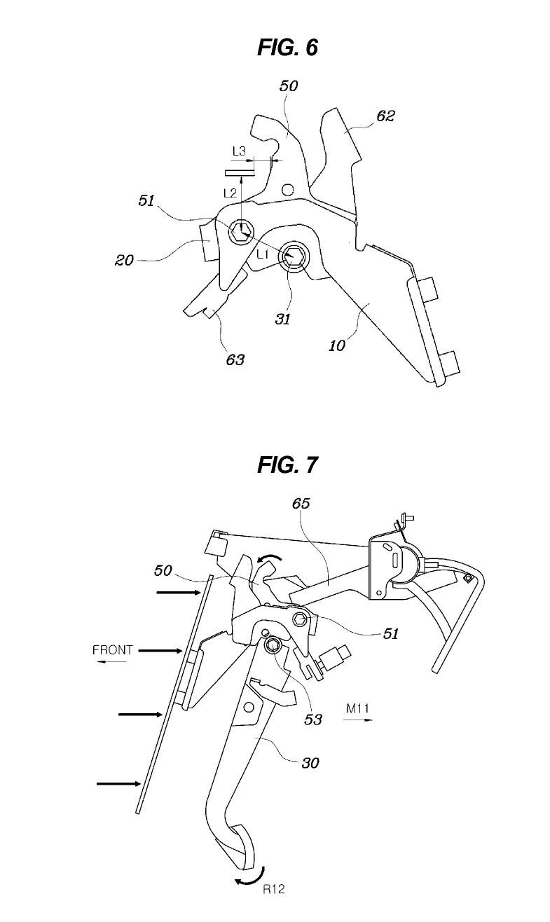

The present invention relates to a brake pedal apparatus having a reverse lever which can be used irrespective of type of vehicle. The brake pedal apparatus according to an exemplary embodiment of the present invention includes a pedal member 10, a hinge bracket 20, a pedal arm 30 and a reverse lever 50. The pedal member 10 is fixed to a dash panel 1 so as to protrude into a cabin, as shown in FIG. 2 and FIG. 7. The hinge bracket 20 is assembled with the pedal member 10, and is configured separately from the pedal member 10 in order to maintain a pedal ratio. The pedal arm 30 is rotatably coupled with the hinge bracket 20 via a pedal hinge 31. The reverse lever 50 is rotatably disposed via a lever hinge 51 which extends through both the pedal member 10 and the hinge bracket 20.

The pedal arm 30 is connected to a brake booster 40 via the push rod 41.

The pedal member 10 according to the present exemplary embodiment includes member side sections 11 which are disposed at both sides to be parallel to each other, plate coupling sections 12 which are bent outward from the front ends of the member side sections 11 so as to be coupled with a base plate 61, and a member-connecting section 13 which connects the front upper surfaces of the member side sections 11 which adjoin to the plate coupling sections 12 to each other in the transverse direction, thereby maintaining lateral stiffness.

The base plate 61 is a component that is coupled with the dash panel 1.

The hinge bracket 20 is disposed so as to be positioned inside an inner space 14 of the pedal member 10 that spans from the rear end to the member-connecting section 13 of the pedal member 10. The inner space 14 of the pedal member 10 is defined as an open space such that the position where the hinge bracket 20 is disposed can be changed in order to maintain the pedal ratio.

In addition, each of the member side sections 11 has a pedal operation recess 15 which is opened downward and is recessed upward. The rear surface of the pedal operation recess 15 forms an inclined surface 15a in order to avoid interruption with either the pedal arm 30 or the pedal hinge 31 when the pedal arm 30 rotates forward while the pedal hinge 31 is being separated from the pedal member 10 in response to the operation of the reverse lever 50.

Here, the inclined surface 15a of the pedal operation recess 15 is formed at a preset angle of incline with which the size of the pedal operation recess 15 is increased gradually in the downward direction.

The hinge bracket 20 includes bracket side sections 21 and a bracket-connecting section 22. The bracket side sections 21 are disposed parallel to the member side sections 11 of the pedal member 10, and have first hinge holes 21a through which the pedal hinge 31 extends and second hinge holes 21b through which the lever hinge 51 extends. The bracket-connecting section 22 connects the rear ends of the bracket side sections 21 to each other in the transverse direction so as to maintain lateral stiffness.

The member side sections 11 of the pedal member 10 also have hinge holes 11a through which the lever hinge 51 extends.

Since the hinge bracket 20 is “C” shaped and the bracket side sections 21 at both sides are disposed parallel to each other, the first and second hinge holes 21a and 21b can be formed simultaneously in the bracket side sections 21 using a piercing mold. In particular, the first and second hinge holes 21a and 21b can be formed at accurate positions, thereby significantly improving machinability.

Among Reference numerals that have not been mentioned above, 62 indicates a cowl bracket, 63 indicates a switch bracket, and 64 indicates a brake switch that couples with the switch bracket 63.

Reference will now be made to the operation of the reverse lever according to the present exemplary embodiment of the present invention.

In an accident such as a collision or a rear-end collision, the pedal member 10 is pushed into the cabin side (in the direction indicated by an arrow M11) and the reverse lever 50 is brought into contact with the cowl crossbar 65, as shown in FIG. 7. The reverse lever 50 rotates counterclockwise about the lever hinge 51 from the shown position (see arrow R11), and the lever protrusion 55 of the reverse lever 50 pushes the pedal hinge 31. Through this, the pedal arm 30 and the pedal hinge 31 are separated from the pedal member 10. At this time, the lower end of the pedal arm 30 is forcibly rotated forward (see an arrow R12), thereby maximizing the distance between the pedal arm and the legs of the driver. This can consequently minimize the injury of the lower limbs of the driver that is caused by the pedal.

When the pedal arm 30 and the pedal hinge 31 are separated from the pedal member 10 and the pedal arm 30 separated from the pedal member 10 is continuously rotated by the reverse lever 50, the inclined surface 15a of the pedal operation recess 15 prevents the pedal arm 30 and the pedal hinge 31 from coming into contact with the pedal member 10. Consequently, the pedal arm 30 can properly perform reverse rotation.

Reference will now be made to the common use of the pedal.

The length of the push rod 41 and the pedal ratio A,B are fixed factors for the guarantee of brake performance irrespective of type of vehicle, whereas the position where the brake booster 40 is disposed or the position of a pad point P1 is a variable that can vary depending on the type of vehicle.

In the pedal ratio, A is the distance from the pad point P1 to the center of the pedal hinge 31, and B is the distance from the point where the pedal arm 30 is coupled with the push rod 41 to the center of the pedal hinge 31. The pedal ratio A:B is generally determined to be 3:1.

The position where the brake booster 40 is disposed can vary depending on a change in the layout depending on the type of vehicle, and the position of the pad point P1 can vary depending on a change in the position where a seat is disposed depending on the type of vehicle.

When the position where the brake booster 40 is disposed or the position of the pad point P1 are changed depending on the type of vehicle, the position where the pedal hinge 31 is disposed must be changed in a corresponding fashion in order to maintain the pedal ratio A:B.

In the structure according to an exemplary embodiment of the present invention, the pedal member 10 and the hinge bracket 20 are provided separately from each other. When the position where the brake booster 40 is disposed or the position of the pad point P1 is changed depending on the type of vehicle, it is possible to set the pedal ratio by moving the position of the hinge bracket 20 in the upward-downward direction or the transverse direction with respect to the pedal member 10. In the state in which the pedal ratio is set, the pedal member 10 and the hinge bracket 20 are completely assembled together. Accordingly, this structure can be used advantageously in common in all types of vehicles.

In addition, after the hinge bracket 20 is moved according to the pedal ratio and then is assembled with the pedal member 10, the reverse lever 50 has to be assembled such that the bracket pedal apparatus can be universally used. At this time, the reverse lever 50 is assembled such that three conditions, including the center-to-center distance L1 between the pedal hinge 31 and the lever hinge 51, the distance L2 between the center of the lever hinge 51 and the cowl crossbar 65 that is positioned above the lever hinge 51, and the distance L3 between one end of the cowl crossbar 65 and the reverse lever 50, can be satisfied.

In addition, when the assembly of the reverse lever 50 is completed, the switch bracket 63 is assembled by changing the position of the switch bracket 63 in the upward-downward direction according to the changed pedal ratio.

According to the present exemplary embodiment of the present invention as described above, when the position where the brake booster 40 is disposed or the position of the pad point P1 is changed, the brake pedal apparatus can be universally used in all types of vehicles since the pedal member 10 and the hinge bracket 20 which are configured separately from each other. There are advantages in that the manufacturing cost can be significantly reduced and the value of a product can be improved.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A driver-protecting brake pedal apparatus comprising:
a pedal member fixed to a dash panel;
a hinge bracket, a first end of which is pivotally coupled to the pedal member, the hinge bracket being selectively separated from the pedal member by an external force in order to maintain a pedal ratio; and
a pedal arm rotatably coupled with a second end of the hinge bracket via a pedal hinge.

2. The driver-protecting brake pedal apparatus according to claim 1, further comprising a reverse lever, wherein the reverse lever is rotatably disposed via a lever hinge which pivotally couples both a first end of the pedal member and the first end of the hinge bracket.

3. The driver-protecting brake pedal apparatus according to claim 2, wherein the reverse lever includes a lever protrusion engaged with the pedal hinge such that when the lever protrusion pushes the pedal hinge by the external force, the hinge bracket rotates with respect to the lever hinge.

4. The driver-protecting brake pedal apparatus according to claim 2, wherein the pedal member comprises:
member side sections disposed at both sides to be parallel to each other;
plate coupling sections bent outward from front ends of the member side sections for coupling with a base plate; and
a member-connecting section connecting front upper surfaces of the member side sections which adjoin to the plate coupling sections to each other in a transverse direction in order to maintain lateral stiffness.

5. The driver-protecting brake pedal apparatus according to claim 4, wherein the hinge bracket is disposed to be positioned inside an inner space of the pedal member which spans from a rear end to the member-connecting section of the pedal member.

6. The driver-protecting brake pedal apparatus according to claim 5, wherein the inner space of the pedal member is opened such that a position where the hinge bracket is disposed is changeable in order to maintain the pedal ratio.

7. The driver-protecting brake pedal apparatus according to claim 4, wherein each of the member side sections has a pedal operation recess which is opened downward and is recessed upward, and wherein a rear surface of the pedal operation recess is configured as an inclined surface in order to avoid interruption with either the pedal arm or the pedal hinge when the pedal hinge is separated from the pedal member and the pedal arm rotates forward in response to an operation of the reverse lever.

8. The driver-protecting brake pedal apparatus according to claim 7, wherein the inclined surface of the pedal operation recess has an angle of incline with which a size of the pedal operation recess is increased gradually in a downward direction.

9. The driver-protecting brake pedal apparatus according to claim 4, wherein the hinge bracket comprises:
bracket side sections disposed at both sides to be parallel to the member side sections, wherein the bracket side sections have first hinge holes through which the pedal hinge extend and second hinge holes through which the lever hinge extends; and
a bracket-connecting section connecting rear ends of the bracket side sections to each other in a transverse direction in order to maintain lateral stiffness.

10. The driver-protecting brake pedal apparatus according to claim 2, wherein the reverse lever is disposed so as to satisfy all of three conditions including a distance between a center of the pedal hinge and a center of the lever hinge, a distance between the center of the lever hinge and a center of a cowl crossbar that is positioned above the lever hinge, and a distance between one end of the cowl crossbar and the reverse lever.
